(19) United States
(12) Patent Application Publication
(10) Pub. No.: US 2008/0081527 A1
(43) Pub. Date: Apr. 3, 2008

(54) Cleaner for a test-card probe

(76) Inventor: Wen-Yu Lu, Tainan Hsien (TW)

Correspondence Address: Wen-Yu Lu, P.O. Box 90, Tainan City, 70499, omitted

(21) Appl. No.: 11/540,557

(22) Filed: Oct. 2, 2006

(51) Int. Cl. B32B 27/04; B32B 19/00

(52) U.S. Cl. 442/149; 428/357

(57) ABSTRACT

A cleaner for a test-card probe is made of fibers irregularly positioned and packed very close, shaped as flat board with a proper thickness. As the fiber has some elasticity so that a test-card probe may not be harmed or damaged when the probe is inserted in and pulled out of the cleaner.

### BACKGROUND OF THE INVENTION

1. Field of the Invention

This invention relates to a cleaner for a test-card probe, especially to one made of fibers and shaped as a flat plate, capable to clean thoroughly dirt stuck on the outer surface of a test-card probe without harming the probe.

2. Description of the Prior Art

Common test-card probes 1 used for testing an IC has an end tip 10 to be pressed on a connect point of an electronic components such as an IC in testing, so the end tip 10 may be apt to be stuck with very tiny dirt, as shown in FIG. 1. Then the sensibility of the probe 1 may be affected somewhat, so the probe 1 has to be often cleaned off tiny dirt 11 stuck on it thoroughly by means of pressured air blown by an air gun or the like. However, this kind of cleaning may not be able to do cleaning work thoroughly to get rid of dirt 11 stuck thereon. In addition, there is another cleaning way using sandpaper 12 for rubbing away dirt 11, but then the end tip 10 of the probe 1 may also be rubbed to wear away a bit, as shown in FIG. 2, shortening the service life of the probe 1. Moreover, a brush may also be used for cleaning the probe 1, but this way may take more time and work than the other ways, and its cleaning effect may not be so complete.

### SUMMARY OF THE INVENTION

This invention has been devised to offer a cleaner for a test-card probe, which is able to clean the dirt stuck on a test-card probe thoroughly, without harming the probe.

The cleaner in the invention is made of fibers irregularly and packed very close, shaped in a flat board with a proper thickness, having some elasticity. A thin film may be added on a lower surface of the cleaner, and a layer of adhesive glue may also be added on an upper surface.

### BRIEF DESCRIPTION OF DRAWINGS

This invention will be better understood by referring to the accompanying drawings, wherein:

FIG. 1 is a side view of a conventional test-card probe stuck with dirt;

FIG. 2 is a side view of the conventional test-card probe cleaned with sandpaper;

FIG. 3 is a cross-sectional view of a cleaner for a test-card probe in the present invention;

FIG. 4 is a cross-sectional view of the cleaner for a test-card probe in the present invention, showing the probe inserted in the cleaner for cleaned;

FIG. 5 is a cross-sectional view of the cleaner for a test-card probe in the present invention, showing the probe pulled out of the cleaner;

FIG. 6 is a cross-sectional view of a second embodiment of a cleaner in the present invention; and,

FIG. 7 is a cross-sectional view of a third embodiment of a cleaner in the present invention.

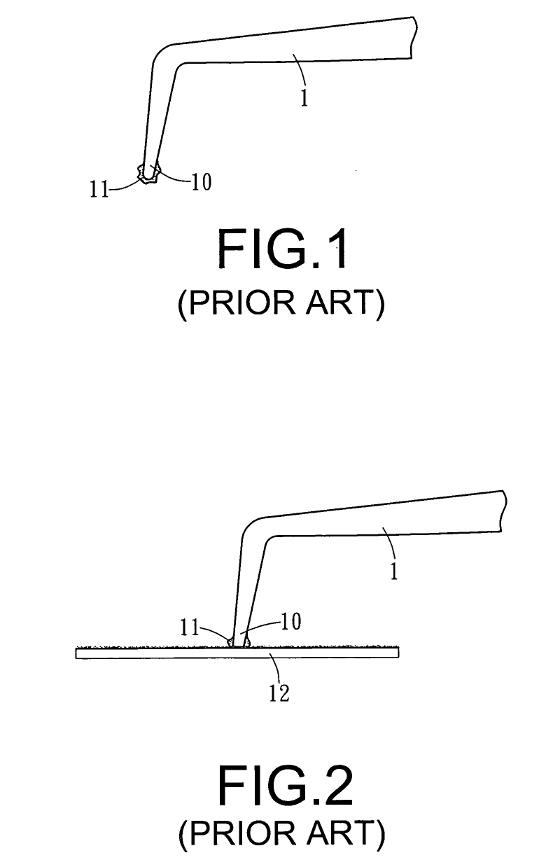

### DETAILED DESCRIPTION OF THE PREFERRED EMBODIMENT

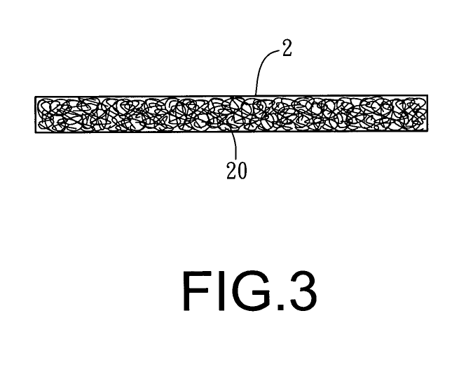

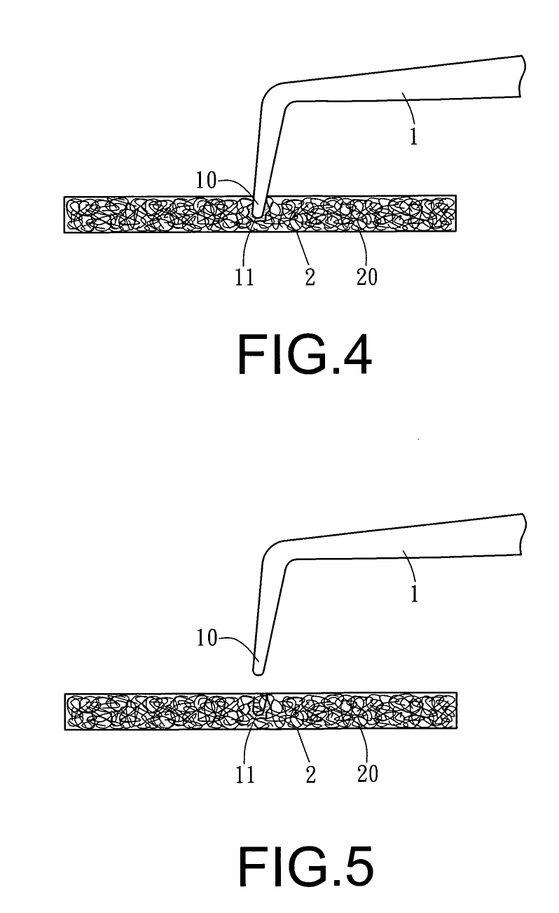

A first embodiment of a cleaner 2 for a test-card probe in the present invention, as shown in FIG. 3, is made of fibers 20 irregularly and packed very close, shaped into a flat board of a proper thickness. The fibers may be made of TPU (thermoplastic polyurethane), PP (polypropylene) or PET (polyethylene telephthalate), In using, as shown in FIGS. 3 and 4, the end tip 10 of a test-card probe 1 stuck with dirt 11 is inserted in the interior of the cleaner 2 and then pulled out of the cleanser 2. Then the fibers in the interior of the cleaner 2 may rub off the dirt 11 on the test-card probe 1 completely during the course of the pulling out operation, with the cleaned-off dirt 11 kept in the interior of the cleanser 2, as shown in FIG. 5. Thus, cleaning work is easily done with quickness by inserting in and pulling out of the test-card probe 1 from the cleaner 2, and in addition, the fibers 20 has some elasticity to produce buffering function when the probe 1 is inserted in or pulled out for cleaning, not harming it by any means, with the service life of the probe prolonged substantially.

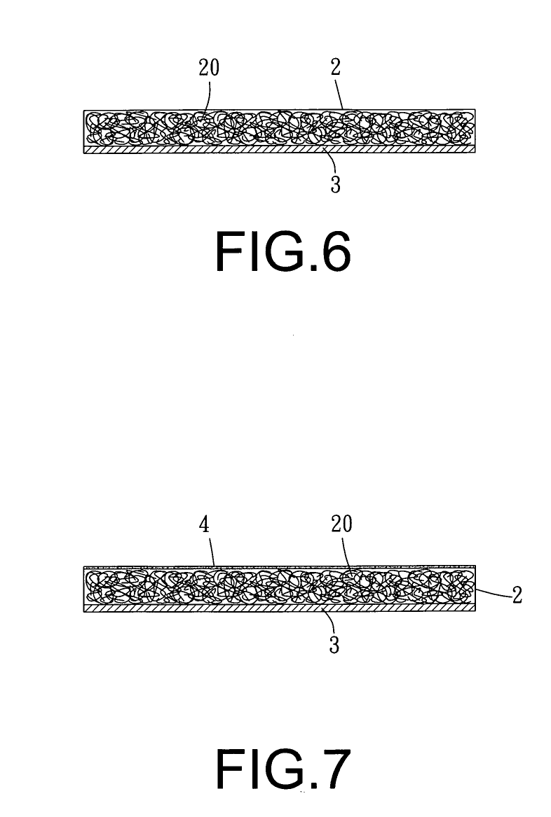

Next, a second embodiment of a cleaner is shown in FIG. 6, having an extra layer of thin film 3 added on a lower surface of the cleaner 2 of the first embodiment, making the cleaner 2 flatter and a little more rigid to be held more conveniently.

Moreover, a third embodiment of a cleaner 2 is shown in FIG. 7, having an extra layer of adhesive glue 4 added on an upper surface of the cleaner 2 of the first embodiment. The adhesive glue 4 is made of acrylic glue so that dirt 11 on a test-card probe 1 may first contact and stick with the adhesive glue 4 when the test-card probe 1 is inserted in the cleaner 2 and the cleaned by the fibers in the interior of the cleaner 2, upgrading cleaning function of the cleaner 2.

While the preferred embodiments of the invention have been described above, it will be recognized and understood that various modifications may be made therein and the appended claims are intended to cover all such modifications that may fall within the spirit and scope of the invention.

What is claimed is:

1. A cleaner for a test-card probe made of fibers positioned irregularly and packed very close and shaped as a flat board having a proper thickness.

2. A cleaner for a test-card probe made of fibers positioned irregularly and packed very close and shaped as a flat board having a proper thickness, and a thin film added on a lower surface

3. A cleaner for a test-card probe made of fibers positioned irregularly and packed very close and shaped as a flat board having a proper thickness, and a layer of adhesive glue added on an upper surface.

4. The cleaner for a test-card probe as claimed in claim 1, wherein a thin film is added on a lower surface, and a layer of adhesive glue is added on an upper surface.
